(19) United States
(12) Patent Application Publication
(10) Pub. No.: US 2025/0283721 A1
(43) Pub. Date: Sep. 11, 2025

(54) Real-Time Heading Angle Calculation Method Based on Polarized Light Field Vector Characteristics

(71) Applicant: Hangzhou City University, Hangzhou (CN)

(72) Inventors: Zhenbing Qiu, Hangzhou (CN); Yanjun Li, Hangzhou (CN)

(21) Appl. No.: 19/217,352

(22) Filed: May 23, 2025

(30) Foreign Application Priority Data
Apr. 27, 2025 (CN) 202510535239.7

(51) Int. Cl. G01C 21/02; G01C 21/20; G01J 4/04

(52) U.S. Cl. CPC G01C 21/02; G01C 21/20; G01J 4/04

(57) ABSTRACT

The present invention relates to a real-time heading angle calculation method based on the vector characteristics of the polarized light field. Aiming at the problems of traditional solar meridian detection methods, such as being easily disturbed in low signal-to-noise ratio scenarios like haze and cloud cover, the occurrence of polarization angle errors and high false detection rates caused by lens distortion, and the difficulty of using single polarization angle information to fully reflect the solar direction, which affects the real-time performance and robustness of heading calculation. This method calculates polarization parameters by using multi-channel polarization images.

### TECHNICAL FIELD

The present invention pertains to the fields of low-altitude economy, image understanding, and biomimetic polarization navigation technologies. Specifically, it relates to a method for real-time detection of the solar meridian and computation of the heading angle from multi-channel polarization images. This method utilizes vector features in the polarization light field, combined with fisheye lens model correction and geometric line detection.

### BACKGROUND ART

Insects' polarization-based navigation mechanisms provide a significant biological foundation for the development of biomimetic navigation technologies. Research by Henze M. J. et al. at the University of Zurich has demonstrated that insects can maintain stable navigation capabilities even under low degrees of polarization, offering biological evidence for polarization navigation under weak signal conditions.

Professor Gao Jun's research group at Hefei University of Technology proposed a heading angle calculation method based on the symmetry detection of atmospheric polarization patterns, significantly improving the accuracy of polarization navigation. To address dynamic cloud interference, they developed a non-local information-based atmospheric polarization pattern restoration method and a de-noising algorithm utilizing both polarization angle and degree of polarization information, effectively mitigating the influence of direct sunlight and field-of-view occlusions based on the Rayleigh scattering model.

To tackle robustness issues in polarization image defogging, Professor Hu Xiaoping's team from the National University of Defense Technology developed a multi-scale singular value decomposition-based image fusion defogging algorithm, significantly enhancing image quality and information accuracy.

Professor Chu Jinkui's group at Dalian University of Technology established a polarization imaging azimuth measurement error propagation model based on the Stokes vector, analyzing the impacts of lens distortion and principal point shifts, thus providing theoretical support for sensor optimization.

In fields such as unmanned aerial vehicles (UAVs), autonomous navigation, and polarization-based navigation, the solar direction plays a critical role as auxiliary positioning information. Existing technologies typically rely on direct sunlight intensity acquisition or estimation based on illumination models. However, these methods are prone to inaccuracies caused by lighting conditions, cloud cover, and non-ideal image deformation due to fisheye lenses, leading to insufficient precision in solar meridian detection and heading angle estimation.

Although some studies have attempted to infer the solar position using polarization angle information, they often lack effective correction for the image distortion induced by fisheye lenses. Moreover, traditional methods typically rely on single polarization angle data, without fully exploiting the vector features inherent in the polarization light field, limiting robustness and precision under variable environmental conditions.

Therefore, there is an urgent need for a new method that integrates polarization light field vector features, lens model correction, image filtering, and geometric line detection to overcome the challenges of high-precision solar meridian detection under cloudy conditions and to achieve accurate heading angle computation.

### SUMMARY OF THE INVENTION

To address the issues where fisheye lens distortion leads to polarization angle errors, causing inaccurate solar positioning and meridian detection; where noise, low contrast, and cloud occlusions obscure solar information in polarization images; and where reliance on single polarization angle information hampers real-time and robust heading computation, the present invention proposes a method based on polarization light field vector features for real-time heading angle computation, enabling high-precision solar meridian detection and accurate heading information acquisition.

To achieve the above objectives, the technical solution of the invention is as follows:

A real-time heading angle computation method based on polarization light field vector features, comprising the following steps:
1. Polarization light field vector analysis and polarization parameter computation;
2. Lens model correction and polarization angle correction;
3. Applying bilateral filtering to the polarization angle image, constructing a circular mask centered on the image to remove low SNR edge regions, and selecting candidate pixels based on a preset threshold to form a binary candidate image for subsequent solar meridian extraction;
4. Detecting the solar meridian based on the Hough transform;
5. Real-time heading angle computation and dynamic correction by combining the detected solar meridian with solar azimuth information obtained through solar vector inversion, calculating the solar azimuth angle, and computing the heading angle using vector dot product and directional constraints.

Furthermore, in the above steps:

A multi-channel polarization image sensor is used to capture raw images containing polarization information at 0°, 45°, 90°, and 135° directions. The images are converted to grayscale and channels are combined; if the images are in color, each channel is overlaid to form a single-channel dataset. For each pixel (x,y), the light intensities at the four polarization angles are calculated: I₀(x,y), I₄₅(x,y), I₉₀(x,y), I₁₃₅(x,y).

Calculate the Stokes parameters:

$$Q ( x , y ) = {I}_{0} ( x , y ) - {I}_{90} ( x , y )$$

$$U ( x , y ) = {I}_{45} ( x , y ) - {I}_{135} ( x , y )$$

Calculate the Angle of Polarization (AoP) and the Degree of Polarization (DoP):

$$AoP ( x , y ) = \frac{1}{2} arctan ( U ( x , y ) , Q ( x , y ) ) \times \frac{180}{π}$$

$$DoP ( x , y ) = \frac{2 \sqrt{{Q ( x , y )}^{2} + {U ( x , y )}^{2}}}{{I}_{0} ( x , y ) + {I}_{45} ( x , y ) + {I}_{90} ( x , y ) {I}_{135} ( x , y )}$$

where AoP_{corr1}(x,y) represent the AoP of each pixel point after correction considering the lens model, and AoP_{corr2}(x,y) represent the AoP of each pixel point after periodic normalization processing.

The corrected AoP image is subjected to bilateral filtering to suppress noise while preserving edge information. A circular mask centered on the image is constructed to eliminate low signal-to-noise ratio regions caused by edge effects. Candidate pixels for subsequent solar meridian extraction are selected based on predefined thresholds, such as AoP absolute values exceeding 85° and DoP values above the 75th percentile of the image. These selected pixels form a binary candidate image for further processing.

Within the candidate region, the Hough Line Transform is applied to the binary image to detect straight lines. The line with the highest number of votes and the greatest length is selected as the solar meridian. The angle θ between this line and the horizontal axis of the image is calculated using the coordinates of the line's endpoints, defining the meridian correction angle: angle_meridian_camera=90°−θ.

In the image, for each pixel within a predefined sampling region, the E-vector is constructed based on its polarization information. The solar vector is then inverted through the following process: for each sampling point, the local E-vector is calculated, incorporating the AoP correction term χ and coordinate inversion based on the lens model (utilizing affine inverse transformation and radial polynomial correction):

$$E = [ \begin{matrix}cos ( zen ) cos ( azi ) cos ( χ ) - sin ( a z i ) sin ( χ ) \\ cos ( zen ) sin ( a z i ) cos ( χ ) + cos ( azi ) sin ( χ ) \\ - sin ( z e n ) cos ( χ )\end{matrix} ]$$

where zen represents the angle between the zenith direction (directly overhead) and the target point (e.g., the Sun), and azi denotes the angle between the reference direction (true north) and the projection of the target point onto the horizontal plane, measured clockwise.

The E-vectors from all sampling points are assembled into matrix A. The eigenvector corresponding to the smallest eigenvalue of A×A^{T} is determined and designated as the solar vector, SolarVector. The solar zenith angle (Sun_zen) and solar azimuth angle (Sun_azi) are then computed from the components of SolarVector:

$$Sun\_zen = arc cos ( {SolarVector}_{z} )$$

$$Sun\_azi = arc tan 2 ( {SolarVector}_{y} , {SolarVector}_{x} )$$

where SolarVectorₓ, SolarVector_{y}, SolarVector_{z} represent the components of the solar vector in the Cartesian coordinate system xyz.

The detected solar meridian is combined with the solar azimuth information obtained from the inverted solar vector to calculate the projection of the solar azimuth angle onto the camera's horizontal plane:

$$Sun\_azi \_plane = Sun\_azi - angle\_meridian \_camera$$

A unit vector SolarVectorₚₗₐₙₑ in the horizontal plane is constructed, and the heading angle heading_angle is calculated using the dot produc:

$${SolarVector}_{plane} = {[ sin ( Sun\_azi \_plane ) , cos ( Sun\_azi \_plane ) , 0 ]}^{T}$$

$$he ading\_angle = arccos ( dot ( {[ cos ( Sun\_azi \_plane ) , sin ( Sun\_azi \_plane ) , 0 ]}^{T} , {SolarVector}_{plane} ) )$$

The heading angleis then adjusted to normalize it within the range [−180°,180°].

After completing the fifth step, new polarization images are acquired, and steps one through five are executed iteratively, enabling real-time provision of the carrier's heading information.

### ADVANTAGES OF THE INVENTION COMPARED TO PRIOR ART

This invention addresses deficiencies in existing solar positioning and heading angle determination technologies, such as inaccuracies caused by fisheye lens distortion, noise interference, and imprecise polarization parameters in polarization images. It proposes a real-time solar meridian detection and heading angle calculation method based on polarization vector features. Compared to existing methods, the invention offers the following advantages:
1. Precise Calibration and Modeling: Utilizing a pre-calibrated fisheye lens model, the invention performs pixel-wise correction and normalization of the AoP for each image pixel. This approach compensates for inaccuracies in traditional methods caused by imaging system distortions, ensuring the accuracy of AoP and DoP information, and providing a reliable physical basis for subsequent solar meridian detection.
2. Multi-level Filtering and Candidate Region Selection: After calculating polarization parameters, the invention applies bilateral filtering to the AoP image for noise reduction. It combines this with a central region mask to select candidate points with AoP values near ±90° and high DoP. This combined selection method effectively suppresses multi-source interference, significantly enhancing the robustness and accuracy of candidate regions, especially under cloud interference or low-contrast conditions.
3. Robust Geometric Detection and Line Extension: Through Hough line transformation in candidate regions, the invention accurately extracts lines representing the solar meridian from noisy images. It employs a line extension strategy to ensure the detected line covers the entire effective area, overcoming errors in traditional methods where line detection is susceptible to local anomalies.
4. E-vector Inversion Mechanism: In the solar vector inversion process, the invention extracts local E-vectors within a predefined sampling area and constructs an E-vector matrix. By utilizing minimum eigenvalue decomposition, it inverts the solar vector, enabling precise calculation of the solar zenith angle and solar azimuth angle. This multi-point fusion inversion technique significantly reduces errors caused by single-point anomalies or noise, ensuring high-precision real-time heading angle calculation.

In summary, by integrating fisheye lens model correction, multi-level filtering with combined selection, robust Hough line detection, and E-vector inversion techniques, this invention effectively suppresses multi-source interference, enhances the measurement accuracy of polarization parameters, and improves the stability of solar meridian detection. It provides a high-precision, robust technical solution for subsequent real-time heading angle calculation, markedly surpassing existing technologies.

### BRIEF DESCRIPTION OF THE DRAWINGS

FIG. 1 illustrates the design flowchart of the real-time heading angle calculation method based on polarization vector features proposed in this invention.

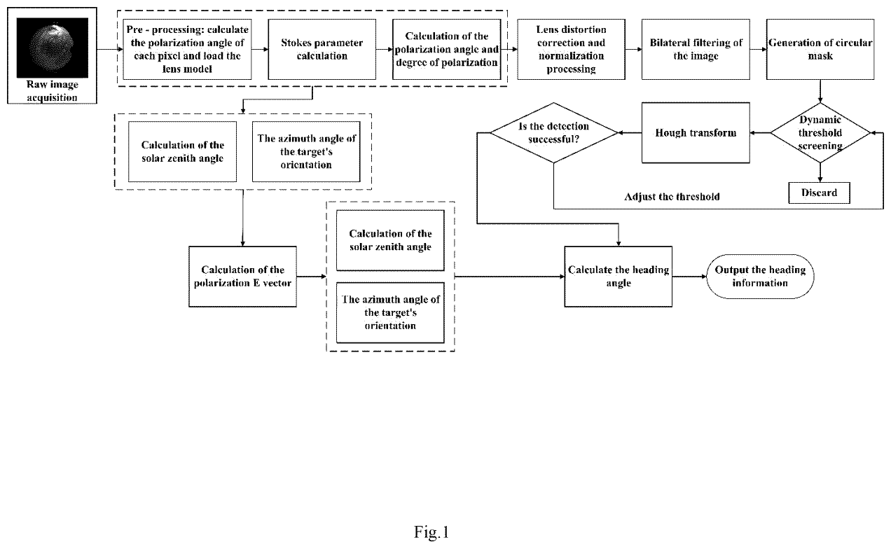

Content not described in detail in this specification pertains to well-known prior art familiar to professionals in the field.

1. A real-time heading angle calculation method based on polarized light field vector characteristics, characterized by comprising the following steps:
Step 1: Polarized Light Field Vector Analysis and Polarization Parameter Calculation. This step involves analyzing the vector characteristics of the polarized light field to compute polarization parameters such as the degree of polarization and polarization angle. Techniques like Stokes parameter measurement or Jones calculus may be employed to quantify the polarization state of the light field.
Step 2: Lens Model Calibration and Polarization Angle Correction. In this phase, the imaging system's lens model is calibrated to correct for distortions and aberrations that may affect the accuracy of polarization measurements. Subsequently, the polarization angles are adjusted to compensate for any systematic errors introduced by the optical components, ensuring precise alignment with the real-world coordinates.
Step 3: Bilateral Filtering of Polarization Angle Images and Candidate Pixel Selection. The polarization angle images undergo bilateral filtering to reduce noise while preserving edge information. A circular mask centered on the image is applied to exclude peripheral regions with low signal-to-noise ratios. Based on predefined thresholds, candidate pixels are selected from the filtered image to identify potential solar meridian lines, resulting in a binary candidate image for further processing.
Step 4: Solar Meridian Detection via Hough Transform. This step involves detecting the solar meridian line within the polarization angle image using the Hough Transform technique. Initially, edge detection algorithms, such as the Canny operator, are applied to identify significant edges in the image. Subsequently, the Hough Transform is utilized to detect straight lines corresponding to the solar meridian, characterized by polarization angles approximately equal to 90 degrees. This method enhances robustness against noise and varying weather conditions, facilitating accurate extraction of the solar meridian line.
Step 5: Real-Time Heading Angle Calculation and Dynamic Correction. In this phase, the detected solar meridian line is combined with solar azimuth information derived from solar vector inversion to compute the solar azimuth angle. By calculating the dot product between the solar azimuth vector and the detected meridian direction, the system determines the heading angle and applies directional constraints. This real-time computation allows for dynamic correction of the heading angle, improving the accuracy and reliability of the navigation system.

2. According to the method described in claim 1, a real-time heading angle calculation method based on polarized light field vector characteristics, characterized in that: In the first step, a multi-channel polarization image sensor is employed to capture raw images containing polarization information at four orientations: 0°, 45°, 90°, and 135°. These images are subjected to grayscale conversion and channel synthesis; if the images are in color, they are converted into single-channel data by superimposing the respective channels. For each pixel (x,y), the light intensity in each channel is calculated: I₀(x,y), I₄₅(x,y), I₉₀(x,y), I₁₃₅(x,y).
Calculate the Stokes parameters:
$$Q ( x , y ) = {I}_{0} ( x , y ) - {I}_{90} ( x , y )$$
$$U ( x , y ) = {I}_{45} ( x , y ) - {I}_{135} ( x , y )$$
Calculate the Angle of Polarization (AoP) and the Degree of Polarization (DoP):
$$AoP ( x , y ) = \frac{1}{2} arctan ( U ( x , y ) , Q ( x , y ) ) \times \frac{180}{π}$$
$$DoP ( x , y ) = \frac{2 \sqrt{{Q ( x , y )}^{2} + {U ( x , y )}^{2}}}{{I}_{0} ( x , y ) + {I}_{45} ( x , y ) + {I}_{90} ( x , y ) {I}_{135} ( x , y )}$$

3. According to the method described in claim 2, a real-time heading angle calculation method based on polarized light field vector characteristics, characterized in that: In the first step, pre-calibrated fisheye lens model parameters—including the geometric center of the lens (x_{c},y_{c}) and corresponding correction coefficients—are loaded. For each pixel, the AoP is corrected for distortion using the following formula:
$${AoP}_{corr 1} ( x , y ) = AoP ( x , y ) - arc tan 2 ( {x}_{c} - x , y - {y}_{c} ) \times \frac{180}{π}$$
$${AoP}_{corr 2} ( x , y ) = arc tan ( tan ( {AoP}_{corr 1} ( x , y ) \times \frac{π}{180} ) ) \times \frac{180}{π}$$
where AoP_{corr1}(x,y) represent the AoP of each pixel point after correction considering the lens model, and AoP_{corr2}(x,y) represent the AoP of each pixel point after periodic normalization processing.

4. According to the method described in claim 3, a real-time heading angle calculation method based on polarized light field vector characteristics, characterized in that: The corrected AoP image is subjected to bilateral filtering to suppress noise while preserving edge information. A circular mask centered on the image is constructed to eliminate low signal-to-noise ratio regions caused by edge effects. Candidate pixels for subsequent solar meridian extraction are selected based on predefined thresholds, such as AoP absolute values exceeding 85° and DoP values above the 75th percentile of the image. These selected pixels form a binary candidate image for further processing.

5. According to the method described in claim 4, a real-time heading angle calculation method based on polarized light field vector characteristics, characterized in that: Within the candidate region, the Hough Line Transform is applied to the binary image to detect straight lines. The line with the highest number of votes and the greatest length is selected as the solar meridian. The angle θ between this line and the horizontal axis of the image is calculated using the coordinates of the line's endpoints, defining the meridian correction angle: angle_meridian_camera=90°−θ.

6. According to the method described in claim 5, a real-time heading angle calculation method based on polarized light field vector characteristics, characterized in that: In the image, for each pixel within a predefined sampling region, the E-vector is constructed based on its polarization information. The solar vector is then inverted through the following process: for each sampling point, the local E-vector is calculated, incorporating the AoP correction term χ and coordinate inversion based on the lens model (utilizing affine inverse transformation and radial polynomial correction):
$$E = [ \begin{matrix}cos ( zen ) cos ( azi ) cos ( χ ) - sin ( a z i ) sin ( χ ) \\ cos ( zen ) sin ( azi ) cos ( χ ) + cos ( azi ) sin ( χ ) \\ - sin ( z e n ) cos ( χ )\end{matrix} ]$$
where zen represents the angle between the zenith direction (directly overhead) and the target point (e.g., the Sun), and azi denotes the angle between the reference direction (true north) and the projection of the target point onto the horizontal plane, measured clockwise.
The E-vectors from all sampling points are assembled into matrix A. The eigenvector corresponding to the smallest eigenvalue of A×A^{T} is determined and designated as the solar vector, SolarVector. The solar zenith angle (Sun_zen) and solar azimuth angle (Sun_azi) are then computed from the components of SolarVector:
$$Sun\_zen = arc cos ( {SolarVector}_{z} )$$
$$Sun\_azi = arc tan 2 ( {SolarVector}_{y} , {SolarVector}_{x} )$$
where SolarVectorₓ, SolarVector_{y}, SolarVector_{z}, represent the components of the solar vector in the Cartesian coordinate system xyz.

7. According to the method described in claim 6, a real-time heading angle calculation method based on polarized light field vector characteristics, characterized in that:
The detected solar meridian is combined with the solar azimuth information obtained from the inverted solar vector to calculate the projection of the solar azimuth angle onto the camera's horizontal plane:
$$Sun\_azi \_plane = Sun\_azi - angle\_meridian \_camera$$
A unit vector SolarVectorₚₗₐₙₑ in the horizontal plane is constructed, and the heading angle heading_angle is calculated using the dot produc:
$${SolarVector}_{plane} = {[ sin ( Sun\_azi \_plane ) , cos ( Sun\_azi \_plane ) , 0 ]}^{T}$$
$$he ading\_angle = arccos ( dot ( {[ cos ( Sun\_azi \_plane ) , sin ( Sun\_azi \_plane ) , 0 ]}^{T} , {SolarVector}_{plane} ) )$$
The heading angle is then adjusted to normalize it within the range [−180°,180°].
After completing the fifth step, new polarization images are acquired, and steps one through five are executed iteratively, enabling real-time provision of the carrier's heading information.
